(19) United States
(12) Patent Application Publication
(10) Pub. No.: US 2012/0294482 A1
(43) Pub. Date: Nov. 22, 2012

(54) ENVIRONMENT RECOGNITION DEVICE AND ENVIRONMENT RECOGNITION METHOD

(75) Inventor: Seisuke Kasaoki, Tokyo (JP)

(73) Assignee: FUJI JUKOGYO KABUSHIKI KAISHA, Tokyo (JP)

(21) Appl. No.: 13/471,775

(22) Filed: May 15, 2012

(30) Foreign Application Priority Data
May 19, 2011 (JP) 2011-112004

(51) Int. Cl. G06K 9/46; G06K 9/00

(52) U.S. Cl. 382/103; 382/170

(57) ABSTRACT

There are provided an environment recognition device and an environment recognition method. The environment recognition device includes: a position information obtaining unit that obtains position information of a target portion in a detection area, the position information including a relative distance to a subject vehicle; a grouping unit that groups the target portions as a target object based on the position information; a luminance obtaining unit that obtains a luminance of an image of the target object; a luminance distribution generating unit that generates a histogram of the luminance of the image of the target object; and a floating substance determining unit that determines whether or not the target object is a floating substance based on a statistical analysis on the histogram.

### CROSS-REFERENCE TO RELATED APPLICATIONS

The present application claims priority from Japanese Patent Application No. 2011-112004 filed on May 19, 2011, the entire contents of which are hereby incorporated by reference.

### BACKGROUND OF THE INVENTION

1. Field of the Invention

The present invention relates to an environment recognition device and an environment recognition method for recognizing a target object based on luminances of the target object in a detection area.

2. Description of Related Art

Conventionally, a technique has been known that detects a target object such as arm obstacle including a vehicle and a traffic light located in front of a subject vehicle for performing control to avoid collision with the detected target object and to maintain a safe distance between the subject vehicle and the preceding vehicle (for example, Japanese Patent Application Laid-Open (JP-A) No. 2001-43496, and JP-A No. 06-298022).

In an area such as a cold district and a district at high altitudes, there is the case in which water vapor floats above a road, or white exhaust gas is emitted from an exhaust pipe of a preceding vehicle. These gases might not be diffused immediately, but might stay. In the control techniques described above, the floating substance such as water vapor or exhaust gas might erroneously be determined as a fixed object such as a wall, and a control might be executed for stopping or decelerating a vehicle for avoiding the floating substance. This might give a feeling of strangeness to a driver.

In view of this, there has been proposed a technique in which a variation (dispersion) amount to an average of distances from each part of a detected object, and when the variation amount exceeds a threshold value, the detected object is determined to be a floating substance, such as water vapor or exhaust gas, with which the vehicle can be in contact (for example, JP-A No. 2009-110168).

For example, there is the case in which water vapor or exhaust gas remains (stays) at a spot in a calm condition. In this case, the variation in the distances from each part of the floating substance is small, so that it is difficult to distinguish the floating substance from a fixed object. There is a wide variety of patterns of the distance distribution that the floating sub, the distance can form. Therefore, the distribution unique to the floating substance cannot be properly specified only by the variation, resulting in that the accuracy of detecting the floating substance is poor.

### BRIEF SUMMARY OF THE INVENTION

In view of such problems, it is an object of the present invention to provide an environment recognition device and an environment recognition method that is capable of accurately detecting a floating substance such as water vapor or exhaust gas.

In order to solve the above problems, an aspect of the present invention provides an environment recognition device that includes: a position information obtaining unit that obtains position information of a target portion in a detection area of a luminance image, the position information including a relative distance to a subject vehicle; a grouping unit that groups the target portions into a target object based on the position information; a luminance obtaining unit that obtains luminances of a target object; a luminance distribution generating unit that generates a histogram of luminances of the target object; and a floating substance determining unit that determines whether or not the target object is a floating substance based on a statistical analysis on the histogram.

The floating substance determining unit may determine whether or not the target object is a floating substance based on one or more characteristic amounts that are calculated from the histogram and include an average, a variance, a skewness, or a kurtosis.

The floating substance determining unit may determine whether or not the target object is a floating substance based on the number of the characteristic amounts failing within respect ve predetermined ranges.

The floating substance determining unit may determine whether or not the target object is a floating substance based on the difference between a predetermined model of a historam of a luminance of a floating substance and a histogram generated by the luminance distribution generating unit.

The floating substance determining unit may represent the difference between the predetermined model of a histogram of a luminance of a floating substance and the histogram generated by the luminance distribution generating unit, and the number of the characteristic amounts falling within the predetermined range, by a score. When a total obtained by adding up the scores within a predetermined number of frames exceeds a threshold value, the floating substance determining unit may determine that the target object is a floating substance.

The luminance distribution generating unit may limit the target object that is used for generating a histogram of luminances to a target object located above a road surface.

In order to solve the above problems, another aspect of the present invention provides an environment recognition method that includes: obtaining position information of a target portion in a detection area of a luminance image, the position information including a relative distance to a subject vehicle; grouping the target portions into a target object based on the position information; obtaining luminances of the target object; generating a histogram of the luminances of the target object; and determining whether or not the target object is a floating substance based on a statistical analysis on the histogram.

According to the present invention, a floating substance such as water vapor or exhaust gas can precisely be detected, whereby the execution of an unnecessary avoiding operation to a floating substance can be prevented.

### BRIEF DESCRIPTION OF THE SEVERAL VIEWS OF THE DRAWINGS

FIG. 1 is a block diagram illustrating a connection relationship in an environment recognition system according to a first embodiment;

FIGS. 2A and 2B are explanatory diagrams for explaining a luminance image and a distance image;

FIG. 3 is a functional block diagram schematically illustration functions of an environment recognition device according to the first embodiment;

FIG. 4 an explanatory diagram for explaining conversion into three-dimensional position information performed by a position information obtaining unit;

FIGS. 5A and 5B are explanatory diagrams for explaining divided regions and a representative distance;

FIG. 6 is an explanatory diagram for explaining grouping processing;

FIGS. 7A and 7B are explanatory diagrams for explaining a skewness and a kurtosis;

FIG. 8 is a flowchart illustrating an overall flow of an environment recognition method according to the first embodiment;

FIG. 9 is a flowchart illustrating a flow of target object specifying processing according to the first embodiment;

FIG. 10 is a flowchart illustrating a flow of floating substance determining processing according to the first embodiment;

FIG. 11 is a functional block diagram schematically illustrating functions of an environment recognition device according to a second embodiment;

FIG. 12 is a flowchart illustrating an overall flow of an environment recognition method according to the second embodiment; and

FIG. 13 is a flowchart illustrating a flow of floating substance determining processing according to the second embodiment.

### DETAILED DESCRIPTION OF THE INVENTION

A preferred embodiment of the present invention will be hereinafter explained in detail with reference to attached drawings. The size, materials, and other specific numerical values shown in the embodiment are merely exemplification for the sake of easy understanding of the invention, and unless otherwise specified, they do not limit the present invention. In the specification and the drawings, elements having substantially same functions and configurations are denoted with same reference numerals, and repeated explanation thereabout is omitted. Elements not directly related to the present invention are omitted in the drawings.

### First Embodiment

### Environment Recognition System 100

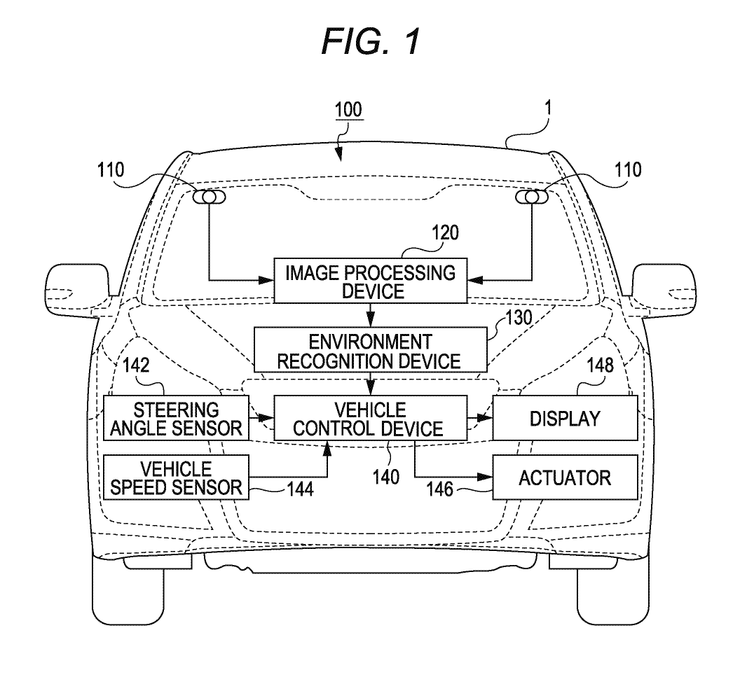

FIG. 1 is a block diagram illustrating a connection relationship in an environment recognition system 100 according to a first embodiment. The environment recognition system 100 includes a plurality of image capturing devices 110 (two image capturing devices 110 in the present embodiment), an image processing device 120, an environment recognition device 130, and a vehicle control device 140 that are provided in a vehicle 1.

The image capturing devices 110 include an imaging element such as a CCD (Charge-Coupled Device) and a CMOS (Complementary Metal-Oxide Semiconductor), and can obtain monochrome image, that is, obtains a monochrome luminance per pixel. In this case, a monochrome image captured by the image capturing devices 110 is referred to as luminance image and is distinguished from a distance image to be explained later. The image capturing devices 110 are disposed to be spaced apart from each other in a substantially horizontal direction so that optical axes of the two image capturing devices 110 are substantially parallel in a proceeding direction of the vehicle 1. The image capturing device 110 continuously generates image data obtained by capturing an image of a target object existing in a detection area in front of the vehicle 1 at every 1/60 seconds (60 fps), for example. In this case, the target object may be not only an independent three-dimensional object such as a vehicle, a traffic light, a road, and a guardrail, but also arm illuminating portion such as a tail lamp, a turn signal, a traffic light that can be specified as a portion of a three-dimensional object. Each later-described functional unit in the embodiment performs processing in response to the update of such image data.

The image processing device 120 obtains image data from each of the two image capturing devices 11, and derives, based on the two pieces of image data, parallax information including a parallax of any block (a set of a predetermined number of pixels) in the image and a position representing a position of the any block in the image. Specifically, the mage processing device 120 derives a parallax using so-called pattern matching that searches a block in one of the image data corresponding to the block optionally extracted from the other image data. The block is, for example, an array including four pixels in the horizontal direction and four pixels in the vertical direction. In this embodiment, the horizontal direction means a horizontal direction for the captured image, and corresponds to the width direction in the real world. On the other hand, the vertical direction means a vertical direction for the captured image, and corresponds to the height direction in the real world.

One way of performing the pattern matching is to compare luminance values (Y color difference signals) between two image data by the block indicating any image position. Examples include an SAD (Sum of Absolute Difference) obtaining a difference of luminance values, an SSD (Sum of Squared intensity Difference) squaring a difference, and an NCC (Normalized Cross Correlation) adopting the degree of similarity of dispersion values obtained by subtracting a mean luminance value from a luminance value of each pixel. The image processing device 120 performs such parallax deriving processing on all the blocks appearing in the detection area (for example, 600 pixels×200 pixels). In this case, the block is assumed to include 4 pixels×4 pixels, but the number of pixels in the block may be set at any value.

Although the image processing device 120 can derive a parallax for each block serving as a detection resolution unit, it is impossible to recognize what kind of target object the block belongs to. Therefore, the parallax information is not derived by the target object, but is independently derived by the resolution (for example, by the block) in the detection area. In this embodiment, an image obtained by associating the parallax information thus derived (corresponding to a later-described relative distance) with image data is referred to as a distance image.

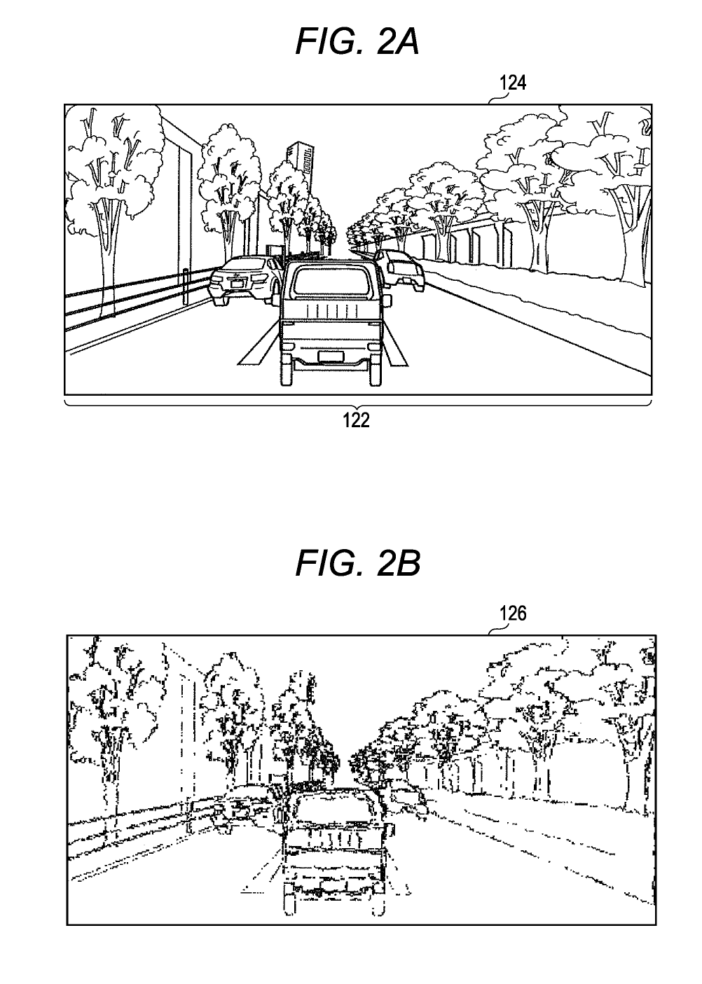

FIGS. 2A and 2B are explanatory diagrams for explaining a luminance image 124 and a distance image 126. For example, Assume that the luminance image (image data) 124 as shown in FIG. 2A is generated with regard to a detection area 122 by the two image capturing devices 110. Here, for the sake of easy understanding, only one of the two luminance images 124 is schematically shown.

The image processing device 120 obtains a parallax for each block from such luminance image 124, and forms the distance image 126 as shown in FIG. 2B. Each block of the distance image 126 is associated with a parallax of the block. In the drawing, for the sake of explanation, a block from which a parallax is derived is indicated by a black dot.

The parallax can be easily specified at the edge portion (portion where there is contrast between adjacent pixels) of objects, and therefore, the block from which parallax is derived, which is denoted with black dots in the distance image 126, is likely to also be an edge in the luminance image 124. Therefore, the luminance image 124 as shown in FIG. 2A and the distance image 126 as shown in FIG. 2B are similar in terms of outline of each target object.

The environment recognition device 130 uses a so-called stereo method to convert the parallax information for each block in the detection area 122 (distance image 126) derived by the image processing device 120 into three-dimensional position information including a relative distance, thereby deriving heights. The stereo method is a method using a triangulation method to derive a relative distance of a target object with respect to the image capturing device 110 from the parallax of the target object. The environment recognition device 130 will be explained later in detail.

The vehicle control device 140 avoids a collision with the target object specified by the environment recognition device 130 and performs control so as to maintain a safe distance from the preceding vehicle. More specifically, the vehicle control device 140 obtains a current cruising state of the subject vehicle 1 based on, for example, a steering angle sensor 142 for detecting an angle of the steering and a vehicle speed sensor 144 for detecting a speed of the subject vehicle 1, thereby controlling an actuator 146 to maintain a safe distance from the preceding vehicle. The actuator 146 is an actuator for vehicle control used to control a brake, a throttle valve, a steering angle and the like. When collision with a target object is expected, the vehicle control device 140 displays a warning (notification) of the expected collision on a display 148 provided in front of a driver, and controls the actuator 146 to automatically decelerate the subject vehicle 1. The vehicle corntrol device 140 can also be integrally implemented with the environment recognition device 130.

(Environment Recognition Device 130)

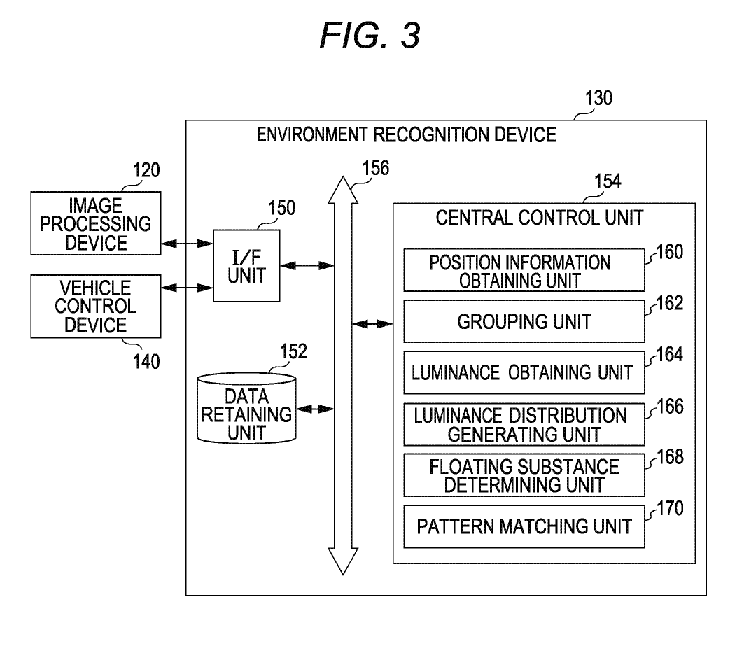

FIG. 3 is a functional block diagram schematically illustrating functions of an environment recognition device 130 according to the first embodiment. As shown in FIG. 3, the environment recognition device 130 includes an I/F unit 150, a data retaining unit 152, and a central control unit 154.

The I/F unit 150 is an interface for interactive information exchange with the image processing device 120 and the vehicle control device 140. The data retaining unit 152 is constituted by a RAM, a flash memory, an HDD and the like, and retains various kinds of information required for processing performed by each functional unit explained below. In addition, the data retaining unit 152 temporarily retains the luminance image 124 and the distance image 126 received from the image processing device 120.

The central control unit 154 is comprised of a semiconductor integrated circuit including, for example, a central processing unit (CPU), a ROM storing a program and the like, and a RAM serving as a work area, and controls the I/F unit 150 and the data retaining unit 152 through a system bus 156. In the present embodiment, the central control unit 154 also functions as a position information obtaining unit 160, a grouping unit 162, a luminance obtaining unit 164, a luminance distribution generating unit 166, a floating substance determining unit 168, and a pattern matching unit 170.

The position information obtaining unit 160 uses the stereo method to convert parallax information, derived by the image processing apparatus 120, for each block in the detection area 122 of the distance image 126 into three-dimensional position information including the width direction x, the height direction y, and the depth direction z. Here, the target portion is supposed to composed of a pixel or a block formed by collecting pixels. In the present embodiment, the target portion has a size equal to the size of the block used in the image processing device 120.

The parallax information derived by the image processing device 120 represents a parallax of each target portion in the distance image 126, whereas the three-dimensional position information represents information about the relative distance of each target portion in the real world. Accordingly, a term such as the relative distance and the height refers to a distance in the real world, whereas a term such as a detected distance refers to a distance in the distance image 126.

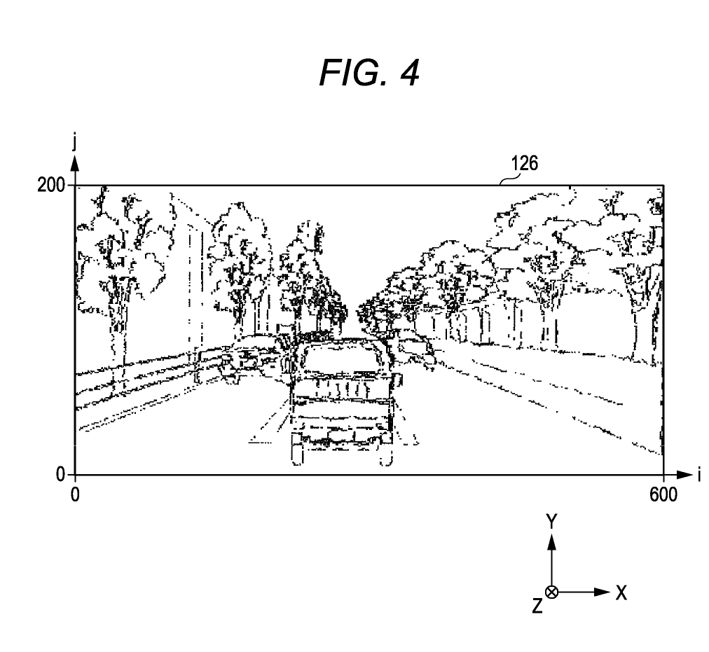

FIG. 4 is an explanatory diagram for explaining conversion into three-dimensional position information by the position information obtaining unit 160. First, the position information obtaining unit 160 treats the distance image 126 as a coordinate system in a pixel unit as shown in FIG. 4. In FIG. 4, the lower left corner is adopted as an origin (0, 0). The horizontal direction is adopted as an i coordinate axis, and the vertical direction is adopted as a j coordinate axis. Therefore, a pixel having a parallax dp can be represented as (i, j, dp) using a pixel position i, j and the parallax dp.

The three-dimensional coordinate system in the real world according to the present embodiment will be considered using a relative coordinate system in which the vehicle 1 is located in the center. The right side of the direction in which the subject vehicle 1 moves is denoted as a positive direction of X axis, the upper side of the subject vehicle 1 is denoted as a positive direction of Y axis, the direction in which the subject vehicle 1 moves (front side) is denoted as a positive direction of Z axis, and the crossing point between the road surface and a vertical line passing through the center of two image capturing devices 110 is denoted as an origin (0, 0, 0). When the road is assumed to be a flat plane, the road surface matches the X-Z plane (y=0). The position information obtaining unit 162 uses (formula 1) to (formula 3) shown below to transform the coordinate of the pixel (i, j, dp) in the distance image 126 into a three-dimensional point (x, y, z) in the real world.

x=CD/2+z·PW·(i−IV) (formula 1)

y=CH+z·PW·(j−JV) (formula 2)

z=KS/dp (formula 3)

Here, CD denotes an interval (baseline length) between the image capturing devices 110, PW denotes a corresponding distance in the real world to a distance between adjacent pixels iTn the image, so-called like an angle of view per pixel, CH denotes an disposed height of the image capturing device 110 from the road surface, IV and JV denote coordinates (pixels) in the image at an infinity point in front of the subject vehicle 1, and KS denotes a distance coefficient (KS=CD/PW).

The grouping unit 162 firstly divides the detection area 122 into plural divided regions with respect to the horizontal direction. The grouping unit 162 then adds up the relative distances included in predetermined distance segments for a block located above the road surface for each of the divided regions, thereby generating a histogram. Then, the grouping unit 162 derives a representative distance corresponding to a peak of the distance distribution formed by the addition. The representative distance corresponding to the peak means a peak value or a value that is in the vicinity of the peak value and that satisfies a condition.

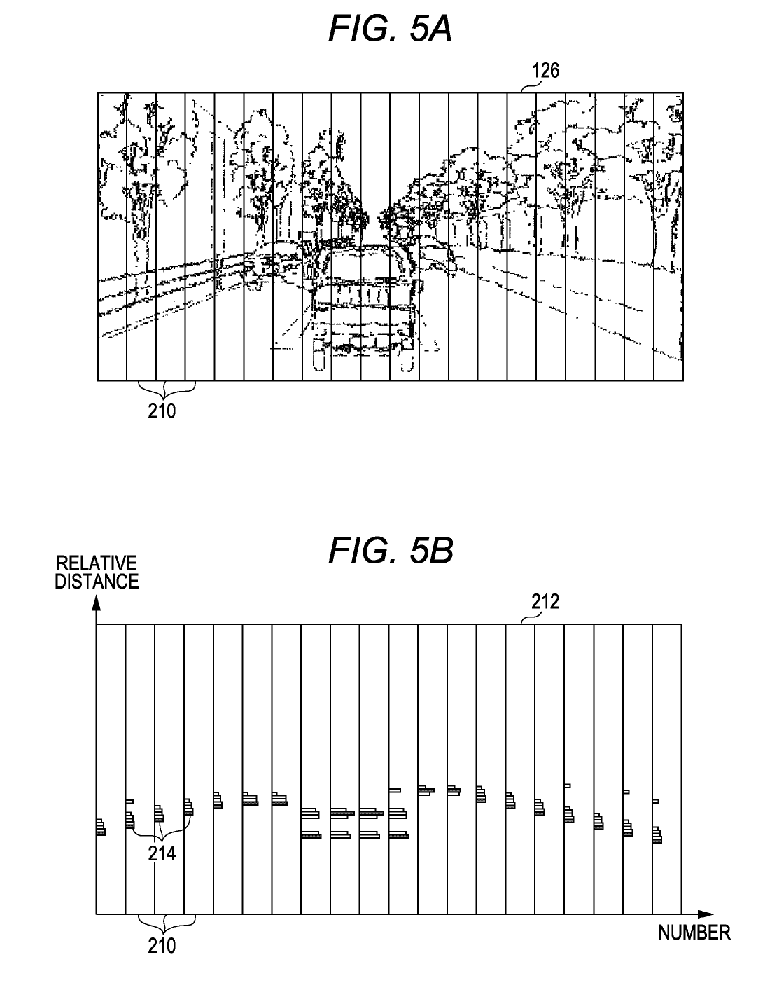

FIG. 5 is an explanatory view for describing divided regions and a representative distance. FIGS. 5A and 5B are explanatory diagrams for explaining divided regions 210 and a representative distance. When the distance image 126 illustrated in FIG. 2B is divided into plural regions with respect to the horizontal direction, strip divided regions 210 are formed as illustrated in FIG. 5A. In an actual implementation, 150 divided strip regions 210 with a width of 4 pixels in the horizontal direction are formed, for example. However, for the sake of convenience of description, the detection area 122 is divided into 20 regions.

Next, the grouping unit 162 refers to the relative distance of each block in each of the divided regions 210 to create a histogram (indicated by a horizontally-long rectangle (bar) in FIG. 5B). Thus, a distance distribution 212 illustrated in FIG. 5B is formed. The longitudinal direction indicates the relative distance z from the vehicle 1, and the lateral direction indicates a number of the relative distances z included in each of divided predetermined distances. FIG. 5B is only a virtual image in order to perform a calculation. The grouping unit 162 does not actually generate a visual image. The grouping unit 162 refers to the distance distribution 212 thus derived, thereby specifying the representative distances (indicated by black solid rectangles in FIG. 5B) 214 that are the relative distances z corresponding to a peak.

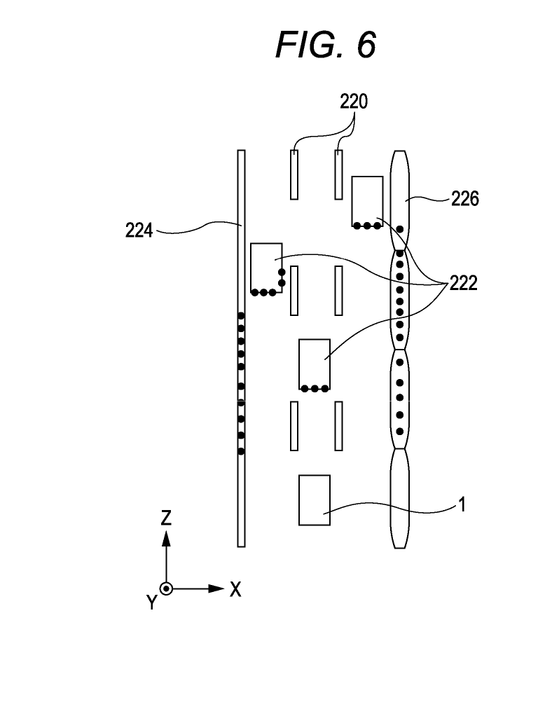

FIG. 6 is an explanatory diagram for explaining grouping processing. FIG. 6 is an overhead view of preceding vehicles 222 and the subject vehicle 1 running on a three-lane road marked out by white lines 220. The grouping unit 162 plots the relative distances z obtained for each divided region 210 on the x-z plane in the real world as illustrated in FIG. 6. In FIG. 6, the relative distances z are plotted on a guardrail 224, a shrubbery 226, and the back and side surfaces of the preceding vehicles 222.

The grouping unit 162 groups, as a subject, the plural subject regions corresponding to the plotted points on the luminance image 124 based on the distance between each of the plotted points (indicated by black circles in FIG. 6) and the direction of the placement of the points.

The luminance obtaining unit 164 specifies an image on the luminance image 124 for each target object. In the present embodiment, the target object image is an image with a rectangle shape enclosing the target regions grouped as a target object, for example. The luminance acquiring unit 164 then obtains the luminance of the target object on the image.

The luminance distribution generating unit 166 generates a histogram for at least pixels of one row (line) (frequency distribution with the luminance being defined as a horizontal axis) in the lateral direction and in the longitudinal direction of the image of the target object. In the present embodiment, the luminance distribution generating unit 166 generates the histogram of the luminance for all pixels included in the image of the target object.

In this case, the luminance distribution generating unit 166 limits the target object which is used for generating the luminance histogram to a target object located above the road surface.

There is a possibility that the vehicle control device 140 will perform an operation of avoiding a target object located above the road surface. Therefore, it is no problem that only target objects located above the road surface are subjected to the determination for determining a floating substance. Since the target objects subjected to the determination for the floating substance is limited to the target objects located above the road surface, the luminance distribution generating unit 166 can reduce a processing load, while preventing the execution of the unnecessary avoiding operation.

The floating substance determining unit 168 determines whether or not a target object is a floating substance based on a statistical analysis on the histogram. Specifically, the floating substance determining unit 168 determines whether or not the target object is a floating substance based on a degree of similarity between a histogram model and one or more characteristic amounts of an average, a variance, a skewness, and a kurtosis of the luminances. In the present embodiment, all of the four characteristic amounts are used.

An average A of luminances is derived according to (formula 4) below. In the description blow, f(n) is defined as a product of a number of pixels with a luminance n included in the image of a target object and a luminance n, min is defined as the minimum value of the luminance, and max is defined as the maximum value of the luminance. The total number of the pixels included in the image of the target object is defined as a total N.

$$A = \frac{{\sum }_{n = min}^{max} f ( n )}{N} \qquad ( formula 4 )$$

A variance V of the luminances is derived according to (formula 5) below. In the description below, when numbers of 1 to n are exclusively assigned to the pixels included in the image of the target object, the luminance of the i pixel is defined as luminance Xi.

$$V = \frac{{\sum }_{i = 1}^{N} {( Xi - A )}^{2}}{N} \qquad ( formula 5 )$$

A skewness SKW of the luminances is derived according to (formula 6) below.

$$SKW = \frac{{\sum }_{i = 1}^{N} {( Xi - A )}^{3}}{{NV}^{1.5}} \qquad ( formula 6 )$$

A kurtosis KRT of the luminances is derived according to (formula 7) below.

$$KRT = \frac{{\sum }_{i = 1}^{N} {( Xi - A )}^{4}}{{NV}^{2}} \qquad ( formula 7 )$$

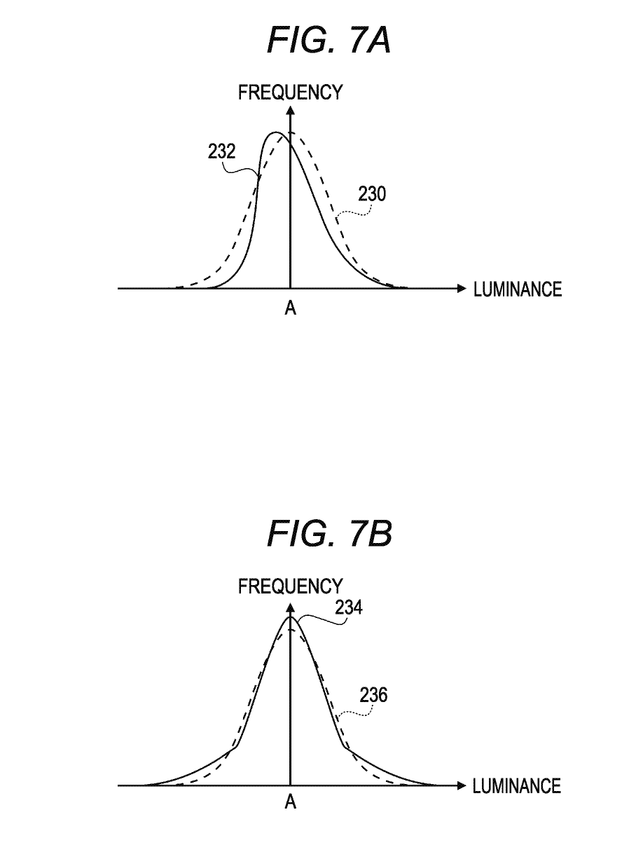

FIGS. 7A and 7B are explanatory diagrams for explaining the skewness SKW and the kurtosis KRT. As illustrated in FIG. 7A, a histogram 230 with a high skewness SKW has high symmetry around the average A, compared to a histogram 232 with a low skewness SKW.

As illustrated in FIG. 7B, in a histogram 234 with a high kurtosis KRT, a slope near the peak is sharp, and a slope at the other portion (foot) is gentle, compared to a histogram 236 with a low kurtosis KRT.

The pixels in the image of a floating substance often have a similar high and whitish luminance. Specifically, the average A of the luminances is relatively high, the variance V is relatively similar to that of a normal distribution, the skewness SKW takes a value indicating relatively a high symmetry, and the kurtosis KRT takes a relatively high value by which a foot portion is wide compared to the normal distribution.

The floating substance determining unit 168 determines whether or not each characteristic amount falls within a predetermined range that is retained in the data retaining unit 152 and that corresponds to each characteristic amount. When there are characteristic amounts falling within the predetermined range, the floating substance determining unit 168 then gives a score for each target object according to the number of the characteristic amounts falling within the predetermined range thereof.

The score is weighted for each characteristic amount. For example, if the average A falls within the predetermined range, 3 points are given, and if the variance V falls within the predetermined range, 5 points are given, for example.

The predetermined range for each characteristic amount is set beforehand as described below. Specifically, a luminance histogram (sample) is generated from each of images obtained by capturing water vapor or white exhaust gas under plural different conditions. The maximum value of each characteristic amount derived from the histogram is defined as an upper limit, and the minimum value thereof is defined as a lower limit, whereby the predetermined range is set.

The floating substance determining unit 168 also derives a difference between a model of a luminance histogram of a floating substance retained in the data retaining unit 152 and the histogram generated by the luminance distribution generating unit 166. The floating substance determining unit 168 calculates a root-mean-square, for example, for the histogram difference, and defines the resultant as a degree of approximation between the histogram model and the histogram generated by the luminance distribution generating unit 166. The floating substance determining unit 168 multiplies the degree of approximation by a predetermined number for weighting, thereby representing the degree of approximation by a score. The floating substance determining unit 168 gives a score to each target object.

Luminance histograms are generated beforehand from images obtained by capturing water vapor or white exhaust gas under plural different conditions and an average histogram is selected out of the brightness histograms, or an average value is taken, to be used for the model of the luminance histogram of a floating substance, for example.

The floating substance determining unit 168 adds the scores of each target object for a predetermined number of frames for example, 10 frames), and derives a total. The scores to be added are weighted for each frame as described below. Specifically, for example, the score the latest frame is added as is, and the score for each of the previous frames is added after multiplied with 0.8 by one or more times depending on how old the frame is.

When the total of the scores exceeds a predetermined threshold value, the floating substance determining unit 168 determines that the target object with this total score is a floating substance.

In this manner, the scores are added for each target object for a predetermined number of frames, and a determination as to whether or not the target object is a floating substance is made based on the total. This configuration can eliminate an influence caused by an error of each frame, thereby being capable of precisely detecting a floating substance.

As described above, the floating substance determining unit 168 determines whether or not a target object is a floating substance based on the difference between the model of the luminance histogram of the floating substance set beforehand and a histogram generated by the luminance distribution generating unit 166.

Since the model of the histogram of a floating substance is used, the floating substance determining unit 168 can reliably recognize a target object as a floating substance, as the target object exhibits a typical histogram of the floating substance.

The floating substance determining unit 168 determines whether or not a target object is a floating substance based on the number of the characteristic amounts falling within a predetermined range corresponding to thereof.

Since the predetermined range is provided, the floating substance determining unit 168 can recognize a floating substance under various conditions even if the tendency of the characteristic amount of the floating substance greatly varies depending upon the condition.

The pattern matching unit 170 performs pattern matching on a target object that is not determined as a floating substance with model data of a three-dimensional object retained beforehand in the data retaining unit 152, thereby determining whether or not the target object corresponds to any one of the three-dimensional objects.

As described above, the floating substance determining unit 168 determines whether or not a target object is a floating substance based on the characteristic amounts derived from the histogram of pixels in the image of the target object. Therefore, the floating substance determining unit 168 can correctly determine that a target object is a floating substance without making an erroneous determination that the floating substance is a fixed object such as a wall, even if a floating substance such as water vapor or exhaust gas is not diffused immediately, but is stayed in calm environment. Accordingly, this configuration can pre-vent the vehicle control device 140 from performing an unnecessary avoiding operation on a floating substance.

(Environment Recognition Method)

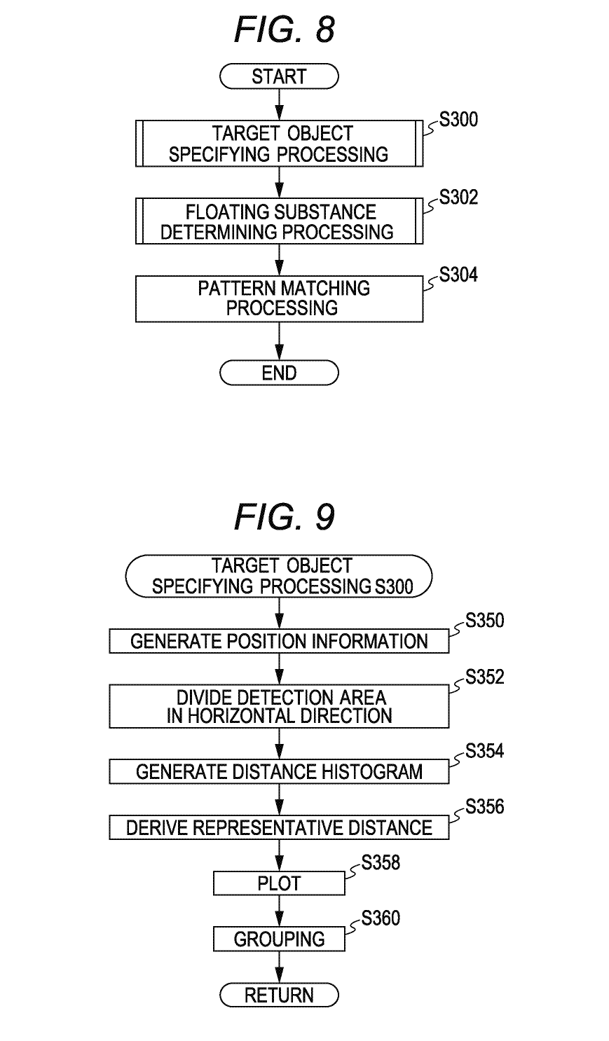

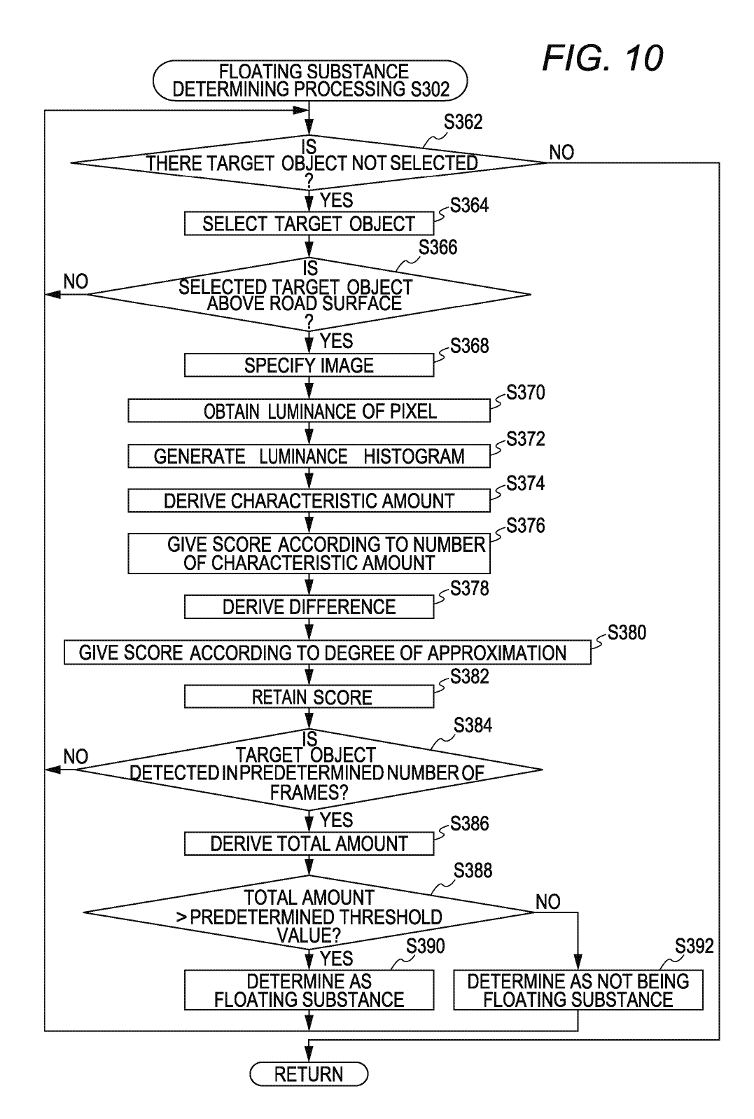

Hereinafter, the particular processings performed by the environment recognition device 130 will be explained based on the flowchart shown in FIGS. 8 to 10. FIG. 8 illustrates an overall flow of interrupt processing when the image processing device 120 transmits the distance image (parallax information) 126. FIGS. 9 and 10 illustrate subroutines therein.

As shown in FIG. 8, when an interrupt occurs according to the environment recognition method in response to reception of the distance image 126, target object specifying processing is executed based on the disparity information, derived by the image processing device 120, for each block in the detection area 122 (S300).

Then, determining processing of whether or not each specified target object is a floating substance (S302). Thereafter, the pattern matching unit 170 performs a pattern matching on a target object that is not determined to be a floating substance with a three-dimensional object (S304). The above-mentioned processings will be specifically be described below.

(Target Object Specifying Processing S300)

As shown in FIG. 9, the position information obtaining unit 160 uses the stereo method to convert parallax information, derived by the image processing apparatus 120, for each block in the detection area 122 of the distance image 126 into three-dimensional position information including the width direction x, the height direction y, and the depth direction z (S350).

The grouping unit 162 firstly divides the detection area 122 into plural divided regions with respect to the horizontal direction (S352). The grouping unit 162 then adds up the relative distances included in predetermined distance segments for a block located above the road surface for each of the divided regions based on the position information, thereby generating a histogram (S354). Then, the grouping unit 162 derives a representative distance corresponding to a peak of the distance distribution formed by the addition (S356).

The grouping unit 162 plots the relative distances z obtained for each divided region 210 on the x-z plane in the real world (S358). The grouping unit 162 groups, as a subject, the plural subject regions corresponding to the plotted points on the luminance image 124 based on the distance between each of the plotted points and the direction of the placement of the points (S360).

(Floating Substance Determining Processing S302)

As shown in FIG. 10, the luminance obtaining unit 164 determines whether or not there are one or more target objects specified in the target object specifying processing in S300 and whether or not there is a target object that has not yet been selected in the floating substance determining processing in S302 (S362). If there are target objects that have not yet been selected (YES in S362), the luminance obtaining unit 164 selects one of the target objects that have not yet been selected (S364).

The luminance obtaining unit 164 determines whether or not the selected target object is located above a road surface (S366). When the target object is located above the road surface (YES in S366), the luminance obtaining unit 164 specifies an image of the selected target object on the luminance image 124 (S368).

Then, the luminance obtaining unit 164 obtains luminances of all pixels in the image of the target object (S370). The luminance distribution generating unit 166 generates a luminance histogram of all pixels included in the image of the target object (S372).

The floating substance determining unit 168 derives 4 characteristic amounts, which are the average, variance, skewness, and kurtosis of the luminance, from the histogram (S374). When there is the characteristic amount falling within the predetermined range, which is set beforehand for each characteristic amount, the floating substance determining unit 168 gives a score according to the number of the characteristic amounts that fall within the corresponding predetermined range (S376).

The floating substance determining unit 168 then derives the difference between the model of the luminance historam of the floating substance set beforehand and the histogram generated by the luminance distribution generating unit 166 (S378). The floating substance determining unit 168 calculates a root-mean-square for the histogram difference, defines the resultant as a degree of approximation, multiplies the degree of approximation with a predetermined number for weighting, thereby representing the degree of approximation by a score, and gives a score to each target object (S380).

The floating substance determining unit 168 retains the score in the data retaining unit 152 in association with the position information and a frame number of the target object (S382).

The floating substance determining unit 168 then determines whether or not the target object corresponding to the selected target object is detected in the frame that is before the current frame by a predetermined number, based on the position information of the target object, for example (S384). If the target object is not detected (NO in S384), the floating substance determining unit 168 returns to the determining processing of the presence of a target object in S362. If the target object is detected (YES in S384), the floating substance determining unit 168 weights the score, retained in the data retaining unit 152, for each of the predetermined, number of frames, and adds the scores of these frames, thereby deriving a total (S386).

The floating substance determining unit 168 then determines whether or not the total score exceeds a predetermined threshold value (S388 in FIG. 10). When the total of the scores exceeds the predetermined threshold value (YES in 8388), the floating substance determining unit 168 determines that the target object with this score is a floating substance, and sets a flag indicating that it is a floating substance to the target object (S390). When the total of the scores does not exceed the predetermined threshold value (NO in S388), the floating substance determining unit 168 determines that the target object is not a floating substance, and sets a flag indicating that the subject is not a floating substance to the target object (S392). The pattern matching unit 170 determines whether or not the pattern matching is executed to the target object according to the flag in the pattern matching processing in S304. The flow then returns to the determining processing of the presence of a target object in S362.

When there is no target object that has not yet been selected in the determining process the presence of a target object in S362 (NO in S362) the floating substance determining processing in S302 is terminated.

As described above, according to the environment recognition method of the present embodiment, a floating substance such as water vapor or exhaust gas can precisely be detected.

### Second Embodiment

The first embodiment has the configuration in which the environment recognition device 130 executes the floating substance determining processing based on monochrome image data of a monochrome image captured by the image capturing devices 110. Hereinafter, a second embodiment will be described in which an environment recognition device 430 executes floating substance determining processing based on image data of a color image.

(Environment Recognition Device 430)

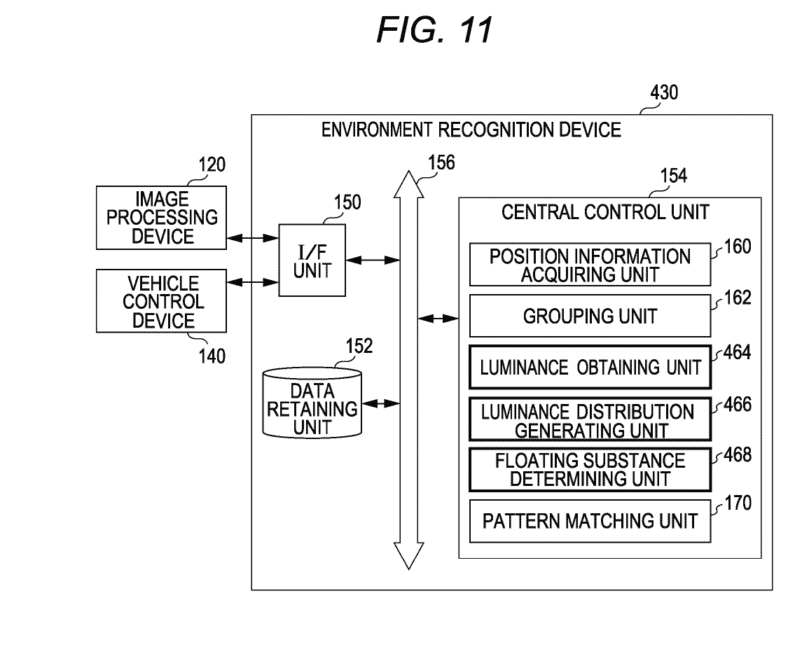

FIG. 11 is a functional block diagram schematically illustrating functions of an environment recognition device 430 according to the second embodiment. As illustrated in FIG. 11, the environment recognition device 430 includes an I/F unit 150, a data retaining unit 152, and a central control unit 154. The central control unit 154 also serves as a position information obtaining unit 160, a grouping unit 162, a luminance obtaining unit 464, a luminance distribution generating unit 466, a floating substance determining unit 468, and a pattern matching unit 170. The I/F unit 150, the data retaining unit 152, the central control unit 154, the position information obtaining unit 160, the grouping unit 162, and the pattern matching unit 170 have substantially the same functions as those in the first embodiment, so that the descriptions thereof are omitted. Here, the luminance obtaining unit 464, the luminance distribution generating unit 466, and the floating substance determining unit 468 which are different from the counterparts in the first embodiment will mainly be described.

The luminance obtaining unit 464 does not obtains a monochrome image, but a color image, that is, luminances of three color phases (red (R), green (G), and blue (B)) per pixel. The brightness distribution generating unit 466 generates a luminance histogram for each of three color phases for one image of a target object.

The floating substance determining unit 468 determines whether or not the target object is a floating substance based on a statistical analysis on three histograms corresponding to the luminances of three color phases. Specifically, the floating substance determining unit 468 derives four characteristic amounts for each of the histograms of luminances of three color phases.

The floating substance determining unit 468 determines whether or not each characteristic amount falls within a setting range thereof. Unlike the first embodiment, the setting range is not a predetermined range, but is set according to the luminances of the image of the target object.

Specifically, after deriving an average A of the luminances of the three color phases of the target object image, the floating substance determining unit 468 derives an average of the averages A of the luminances of the three color phases. The floating substance determining unit 468 sets the setting range having a predetermined range around the derived average of the three color phases.

The floating substance determining unit 468 determines whether or not the average A of the luminances of the three color phases falls within the setting range. When the average A falls within the setting range, the floating substance determining unit 468 gives a score.

The floating substance determining unit 468 executes similar processing to the other characteristic amounts, that is, the variance V, the skewness SKW, and the kurtosis KRT, and give a point for each of them.

The floating substance determining unit 468 then derives a difference between three predetermined models of the luminance histograms of the three color phases of the floating substance and the histograms generated by the luminance distribution generating unit 466 respectively. The floating substance determining unit 468 calculates a root-mean-square for the histogram difference for each color phase, defines the resultant as a degree of approximation, multiplies the degree of approximation by a predetermined number for weighting, thereby representing the degree of approximation by a score, and gives a score to each target object.

Like the first embodiment, the floating substance determining unit 468 adds the scores for each subject by a predetermined number of frames, and derives a total. When the total of the scores exceeds a predetermined threshold value, the floating substance determining unit 468 determines that the target object with this total is a floating substance.

As described above, according to the environment recognition device 430 of the present embodiment, a floating substance such as water vapor or exhaust gas can precisely be detected.

(Environment Recognition Method)

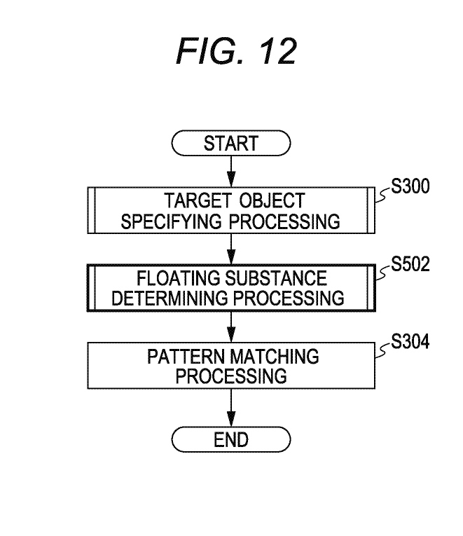

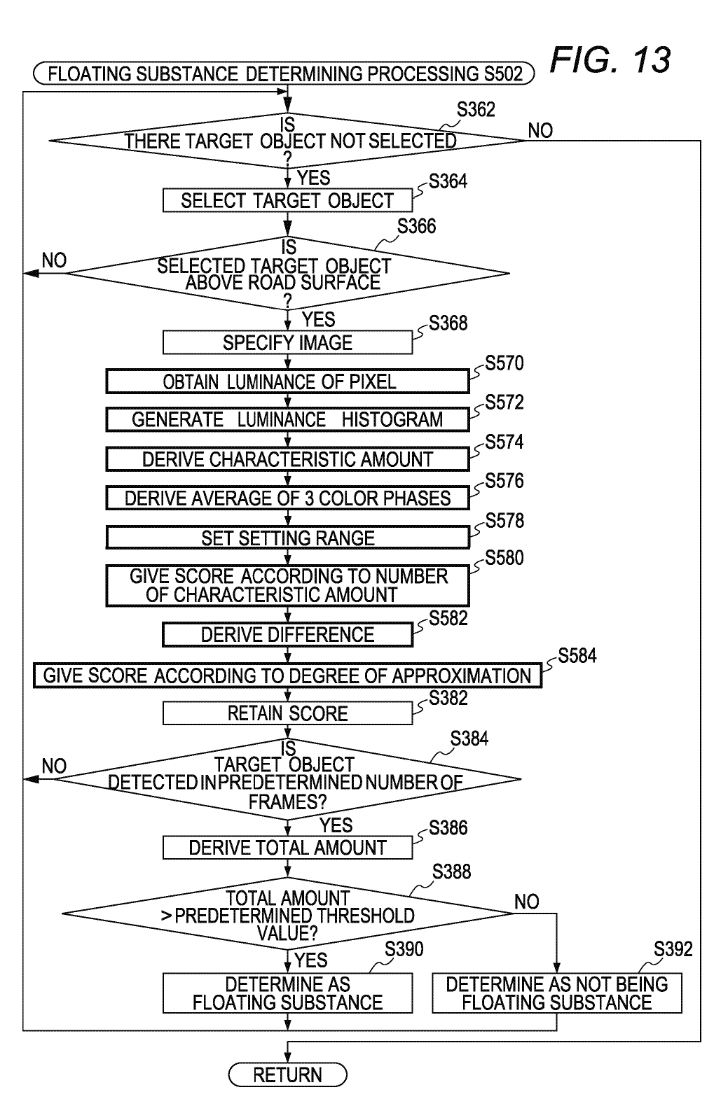

Herein rafter, the particular processings performed by the environment recognition device 430 will be explained based on the flowchart shown in FIGS. 12 and 13. FIG. 12 illustrates an overall flow of interrupt processing when the image processing device 120 transmits the distance image (parallax information) 126. FIG. 13 illustrates illustrate subroutines therein.

As shown in FIG. 12, when an interrupt occurs according to the environment recognition method in response to reception of the distance image 126, target object specifying processing is executed based on the disparity information, derived by the image processing device 120, for each block in the detection area 122 (S300).

Then, determining processing of whether or not each specified target object is a floating substance (S502). Thereafter, the pattern matching unit 170 performs a pattern matching on a target object that is not determined to be a floating substance with a three-dimensional object (S304). The above-mentioned processings will be specifically described below. However, since the target object specifying processing in S300 is substantially same as the counterpart described in the first embodiment, the description thereof is omitted.

(Floating Substance Determining Processing S502)

The floating substance determining processing in S502 will be described with reference to FIG. 13. Since the processings from determining processing of the presence of a target object in S362 to image specifying processing in S368 are substantially same as the counterparts in the first embodiment, the descriptions thereof are omitted.

The luminance obtaining unit 464 obtains luminances of the three color phases of all pixels in the image of the target object (S570). The luminance distribution generating unit 466 generates luminance histograms of the three color phases of all pixels included in the image of the target object (S572).

The floating substance determining unit 468 derives four characteristic amounts for each of the luminance histograms of the three color phases (S574). The floating substance determining unit 468 then derives an average of each characteristic amount of the three color phases (S576). The floating substance determining unit 468 sets the setting range having a predetermined range around the derived average of the three color phases (S578). When each characteristic amount falls within the setting range thereof, the floating substance determining unit 468 then a score to each target object according to the number of the characteristic amounts falling within the setting range thereof (S580).

The floating substance determining unit 468 then derives a difference between each of three predetermined models of the luminance histograms of the three color phases of the floating substance and the histograms generated by the luminance distribution generating unit 466 respectively (S582). The floating substance determining unit 468 calculates a root-mean-square for the histogram difference, defines the resultant as a degree of approximation, multiplies the degree of approximation by a predetermined number for weighting, thereby representing the degree of approximation by a score, and gives a score to each target object (S584).

Since the processings from the score retaining processing in S382 to the determining processing in S392 of determining that the target object is not a floating substance are substantially the same as the counterparts in the first embodiment, the descriptions thereof are omitted.

As described above, according to the environment recognition method of the present embodiment, a floating substance such as water vapor or exhaust gas can precisely be detected.

In addition, a program for allowing a computer to function as the environment recognition device s 130 and 430 is also provided as well as a storage medium such as a computer-readable flexible disk, a magneto-optical disk, a ROM, a CD, a DVD, a BD storing the program. Here, the program means a data processing function described in any language or description method.

While a preferred embodiment of the present invention has been described hereinabove with reference to the appended drawings, it is to be understood that the present invention is not limited to such embodiment. It will be apparent to those skilled in the art that various changes may be made without departing from the scope of the invention.

In the above embodiments, the three-dimensional position of the target object is derived based on the parallax between image data using the plurality of image capturing devices 110. However, the present invention is not limited to such case. Alternatively, for example, a variety of known distance measuring devices such as a laser radar distance measuring device may be used. In this case, the laser radar distance measuring device emits laser beam to the detection area 122, receives light reflected when the laser beam is irradiated the object, and measures the distance to the object based on the time required for this event.

The above embodiments describe examples in which the position information obtaining unit 160 receives the distance image (parallax information) 126 from the image processing device 120, and generates the three-dimensional position information. However, the present invention is not limited to such case. The image processing device 120 may generate the three-dimensional position information in advance, and the position information obtaining unit 162 may obtain the generated three-dimensional position information. Such a functional distribution car reduce the processing load of the environment recognition devices 130 and 430.

In the above embodiment, the position information obtaining unit 160, the grouping unit 162, the luminance obtaining units 164 and 464, the luminance distribution generating units 166 and 466, the floating substance determining units 168 and 468, and the pattern matching unit 170 are configured to be operated by the central control unit 154 with software. However, the functional units may be configured with hardware.

The steps of the environment recognition method in this specification do not necessarily need to be processed chronologically according to the order described in the flowchart. The steps may be processed in parallel, or may include processings using subroutines.

The present invention can be used for an environment recognition device and an environment recognition method for recognizing a target object based on the luminances of the target object in a detection area.

1. An environment recognition device comprising:
a position information obtaining unit that obtains position information of a target portion in a detection area of a luminance image, the position information including a relative distance to a subject vehicle;
a grouping unit that groups the target portions into a target object based on the position information;
a luminance obtaining unit that obtains luminances of a target object;
a luminance distribution generating unit that generates a histogram of luminances of the target object; and
a floating substance determining unit that determines whether or not the target object is a floating substance based on a statistical analysis on the histogram.

2. The environment recognition device according to claim 1, wherein the floating substance determining unit determines whether or not the target object is a floating substance based on one or more characteristic amounts that are calculated from the histogram and include an average, a variance, a skewness, or a kurtosis.

3. The environment recognition device according to claim 2, wherein the floating substance determining unit determines whether or not the target object is a floating substance based on the number of the characteristic amounts falling within respective predetermined ranges.

4. The environment recognition device according to claim 1, wherein the floating substance determining unit determines whether or not the target object is a floating substance based on the difference between a predetermined model of a histogram of a luminance of a floating substance and a histogram generated by the luminance distribution generating unit.

5. The environment recognition device according to claim 2, wherein the floating substance determining unit determines whether or not the target object is a floating substance based on the difference between a predetermined model of a histogram of a luminance of a floating substance and a histogram generated by the luminance distribution generating unit.

6. The environment recognition device according to claim 3, wherein the floating substance determining unit determines whether or not the target object is a floating substance based on the difference between a predetermined model of a histogram of a luminance of a floating substance and a histogram generated by the luminance distribution generating unit.

7. The environment recognition device according to claim 2, wherein:
the floating substance determining unit represents the difference between the predetermined model of a histogram of a luminance of a floating substance and the histogram generated by the luminance distribution generating unit, and the number of the characteristic amounts falling within the predetermined range, by a score, and
when a total obtained by adding up the scores within a predetermined number of frames exceeds a threshold value, the floating substance determining unit may determine that the target object is a floating substance.

8. The environment recognition device according to claim 1, wherein the luminance distribution generating unit limits the target object that is used for generating a histogram of luminances to a target object located above a road surface.

9. The environment recognition device according to claim 2, wherein the luminance distribution generating unit limits the target object that is used for generating a histogram of luminances to a target object located above a road surface.

10. The environment recognition device according to claim 3, wherein the luminance distribution generating unit limits the target object that is used for generating a histogram of luminances to a target object located above a road surface.

11. The environment recognition device according to claim 4, wherein the luminance distribution generating unit limits the target object that is used for generating a histogram of luminances to a target object located above a road surface.

12. The environment recognition device according to claim 5, wherein the luminance distribution generating unit limits the target object that is used for generating a histogram of luminances to a target object located above a road surface.

13. The environment recognition device according to claim 6, wherein the luminance distribution generating unit limits the target object that is used for generating a histogram of luminance to a target object located above a road surface.

14. The environment recognition device according to claim 7, wherein the luminance distribution generating unit limits the target object that is used for generating a histogram of luminances to a target object located above a road surface.

15. An environment recognition method comprising: obtaining position information of a target portion in a detection area of a luminance image, the position information including a relative distance to a subject vehicle;
grouping the target portions into a target object based on the position information;
obtaining luminances of the target object;
generating a histogram of the luminances of the target object; and
determining whether or not the target object is a floating substance based on a statistical analysis on the histogram.
